(19) United States
(12) Patent Application Publication
(10) Pub. No.: US 2026/0079044 A1
(43) Pub. Date: Mar. 19, 2026

(54) OPTICAL SENSOR HAVING MICROSPHERE STRUCTURE

(71) Applicant: LITE-ON SINGAPORE PTE. LTD., Singapore (SG)

(72) Inventors: Wei-Xian Choo, Singapore (SG); RUI-TAO ZHENG, Singapore (SG); GUANG-LI SONG, Singapore (SG)

(21) Appl. No.: 19/317,162

(22) Filed: Sep. 3, 2025

(30) Foreign Application Priority Data
Sep. 13, 2024 (SG) 10202402861Y
Aug. 20, 2025 (SG) 10202502352V

(51) Int. Cl. G01J 1/04; G01J 1/42

(52) U.S. Cl. CPC G01J 1/0411; G01J 1/42

(57) ABSTRACT

An optical sensor having a microsphere structure includes a light-permeable layer, a photoelectronic unit and a substrate. The light-permeable layer includes a microsphere support structure and a plurality of microsphere lenses. The microsphere support structure is disposed on the substrate. The plurality of microsphere lenses are disposed on the microsphere support structure. Each of the plurality of microsphere lenses has a radius and a height that is less than or equal to the radius. The photoelectronic unit is electronically connected to the substrate. The photoelectronic unit is configured to receive a light that travels through at least one of the plurality of microsphere lenses or the microsphere support structure.

### CROSS-REFERENCE TO RELATED PATENT APPLICATION

This application claims the benefit of priorities to Singapore Provisional Patent application Ser. No. 10202402861Y, filed on Sep. 13, 2024. The entire content of the above identified applications are incorporated herein by reference.

This application claims the benefit of priority to Singapore patent application Ser. No. 10202502352V, filed on Aug. 20, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical sensor, and more particularly to an optical sensor having a microsphere structure.

### BACKGROUND OF THE DISCLOSURE

Optical sensors are devices used to detect changes in light and convert them into electrical signals. If the light signal incident to the optical sensor can be highly concentrated onto an active area of the photodiode, the optical sensor is able to more accurately detect light intensity of the light signals and further calculate a distance based on the calculated light intensity, especially when energy of the light signal is weak. However, conventional optical sensors generally have poor light sensitivity.

### SUMMARY OF THE DISCLOSURE

In response to the above-referenced technical inadequacies, the present disclosure provides an optical sensor having a microsphere structure. The optical sensor includes a substrate, a light-permeable layer and a photoelectronic unit. The light-permeable layer includes a microsphere support structure and a microsphere lens. The microsphere support structure is disposed on the substrate. The microsphere lens is disposed on the microsphere support structure. A height of the microsphere is less than or equal to a radius of the microsphere lens. The photoelectronic unit is disposed inside the microsphere support structure along a path that light travels after passing through the microsphere lens. The photoelectronic unit is electronically connected to the substrate. The photoelectronic unit is configured to receive a light that travels through the microsphere lens and the microsphere support structure.

In order to solve the above-mentioned problems, one of the technical aspects adopted by the present disclosure is to provide an optical sensor having a microsphere structure. The optical sensor includes a substrate, a light-permeable layer and a photoelectronic unit. The light-permeable layer includes a microsphere support structure and a microsphere lens. The microsphere support structure is disposed on the substrate. The plurality of microsphere lenses are disposed on the microsphere support structure. A height of the plurality of microsphere lenses is less than or equal to a radius of each of the microsphere lenses. The photoelectronic unit is electronically connected to the substrate. The photoelectronic unit is configured to receive a light that travels through at least one of the plurality of microsphere lenses or the microsphere support structure.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic structural view of an optical sensor having a microsphere structure according to a first embodiment of the present disclosure;

FIG. 2 is a schematic structural view of an optical sensor having a microsphere structure according to a second embodiment of the present disclosure;

FIG. 3 is a schematic structural view of an optical sensor having a microsphere structure according to a third embodiment of the present disclosure;

FIG. 4 is a side view of a microsphere lens included in an optical sensor having a microsphere structure according to a fourth embodiment of the present disclosure;

FIG. 5 is a side view of a microsphere lens included in an optical sensor having a microsphere structure according to a fifth embodiment of the present disclosure;

FIG. 6 is a side view of a microsphere lens included in an optical sensor having a microsphere structure according to a sixth embodiment of the present disclosure;

FIG. 7 is a side view of a microsphere lens included in an optical sensor having a microsphere structure according to a seventh embodiment of the present disclosure;

FIG. 8 is a schematic structural view of an optical sensor having a microsphere structure according to an eighth embodiment of the present disclosure;

FIG. 9 is a side view of FIG. 8;

FIG. 10 is a plan view of the optical sensor having a microsphere structure according to the eighth embodiment of the present disclosure;

FIG. 11 is a schematic diagram of a curve of a normalized flux versus radiuses of the microsphere lens of the optical sensor having the microsphere structure according to the eighth embodiment of the present disclosure;

FIG. 12 is a schematic diagram of a curve of a normalized flux versus a horizontal pitch of the microsphere lens of the optical sensor having the microsphere structure according to the eighth embodiment of the present disclosure;

FIG. 13 is a schematic diagram of a curve of a normalized flux versus a longitudinal pitch of the microsphere lens of the optical sensor having the microsphere structure according to the eighth embodiment of the present disclosure; and

FIG. 14 is a bar graph in which a vertical axis represents a normalized flux and a horizontal axis represents the number of microsphere lenses of the optical sensor having the microsphere structure according to the eighth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein.

Numbering terms such as “first”, “second” or “third” can be used to describe various components, signals or the like, which are for distinguishing one component/signal from another one only, and are not intended to, nor should be construed to impose any substantive limitations on the components, signals or the like.

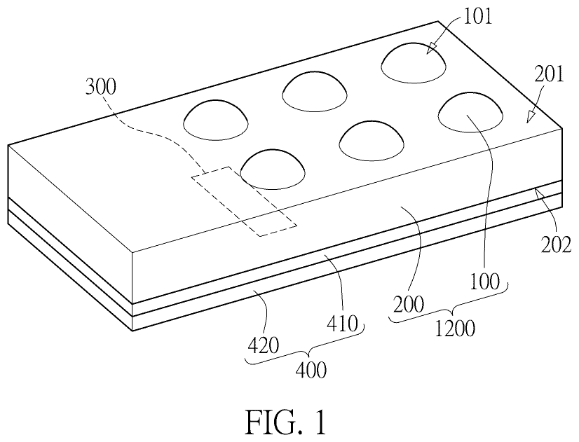

Reference is made to FIG. 1, which is a schematic structural view of an optical sensor having a microsphere structure according to a first embodiment of the present disclosure.

The optical sensor of the present disclosure includes a light-permeable layer 1200, a photoelectronic unit 300 and a substrate 400. The light-permeable layer 1200 includes a microsphere support structure 200, and one or more microsphere lenses 100 such as six microsphere lenses 100 shown in FIG. 1. The microsphere lens 100 is a microlens having a spherical shape.

The microsphere support structure 200 has a front surface 201 and a back surface 202. The plurality of microsphere lenses 100 are disposed on the front surface 201 of the microsphere support structure 200. The front surface 201 described herein is a top surface facing light that is incident to the light-permeable layer 1200. The back surface 202 is a bottom surface disposed opposite to the front surface 201. The light described herein may be ambient light from an environment or another light source, and may include light rays, light beams or a combination thereof.

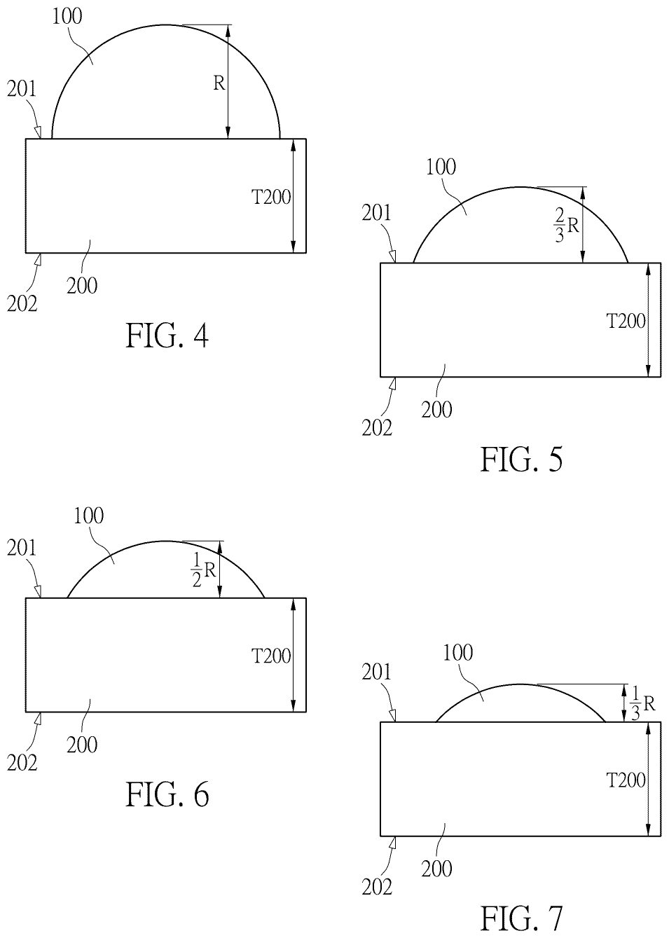

The microsphere support structure 200 is disposed on the substrate 400. A radius R of each of the plurality of microsphere lenses 100 may be the radius R marked in FIG. 4 to FIG. 7. A height of each one of the plurality of microsphere lenses 100 is less than or equal to the radius R of the one of the plurality of microsphere lenses 100. The photoelectronic unit 300 may be partially located in a spherical space defined by the radius R of one of the plurality of microsphere lenses 100.

The photoelectronic unit 300 is electronically connected to the substrate 400. The substrate 400 may include one or more structures or layers such as, but not limited to, a circuit layer 410 and a plate 420. The substrate 400 may be a printed circuit board (PCB), a glass substrate, a silicon substrate, a flexible substrate, a ceramic substrate or another substrate made of various materials. The circuit layer 410 and the plate 420 are sequentially stacked on the back surface 202 of the back microsphere support structure 200.

The plurality of microsphere lenses 100 may be integrally formed with the microsphere support structure 200, for example, through a molding process. In other words, the plurality of microsphere lenses 100 and the microsphere support structure 200 are integrally formed as a single one-piece structure.

For example, the light-permeable layer 1200 may be made of glass, polymers, silica (SiO₂), other transparent materials or light-transmitting materials for transmitting light to the photoelectronic unit 300.

It is worth noting that, in the present disclosure, each of the plurality of microsphere lenses 100 of the optical sensor includes an optical surface 101 having a spherical curvature. This spherical curvature is a geometric measure of how much the optical surface 101 bends and is reciprocal of the radius R of the microsphere lens 100.

Ideally, each of the plurality of microsphere lenses 100 is perfectly symmetrical in a three-dimensional space, specifically exhibiting spherical symmetry. Optical behavior of each of the plurality of microsphere lenses 100 is symmetric in three dimensions. Geometrically, each of the plurality of microsphere lenses 100 may be a nearly perfect spherical micro-object made of glass or a high-refractive-index material. However, in practice, due to manufacturing imperfections or other factors, each of the plurality of microsphere lenses 100 may have a non-ideal spherical shape such as a slight ellipticity shape, an inhomogeneous refractive index and slight deformation, the modified aspects of which are also included in implementation of the present disclosure.

The plurality of microsphere lenses 100 may have one or more same features with each other, for example, the same spherical curvature, the same radius, the same circular cross-section area, the same height, the same size or any combination thereof.

The optical surface 101 of each of the plurality of microsphere lenses 100 may be a smooth outer surface, a structured surface (such as a photonic crystal surface or an anti-reflection surface) or another structure surface.

A center of each of the plurality of microsphere lenses 100 is on a back side of the microsphere lens 100. Therefore, the optical surface 101 of each of the plurality of microsphere lenses 100 is a convex surface, the spherical curvature of which is a positive curvature.

The microsphere lenses 100 are disposed separately from each other, or the plurality of microsphere lenses 100 are spaced apart from each other by a distance. The distance between any two ones of the plurality of microsphere lenses 100 may be the same as or different from that between another two ones of the plurality of microsphere lenses 100.

The plurality of microsphere lenses 100 may be arranged in an array. For example, as shown in FIG. 1, the plurality of microsphere lenses 100 are arranged in an array of 3 rows and 2 columns, but the present disclosure is not limited thereto.

The photoelectronic unit 300 is attached on the microsphere support structure 200. Each of the plurality of microsphere lenses 100 is positioned directly above or diagonally above the photoelectronic unit 300.

The photoelectronic unit 300 is encapsulated between the microsphere support structure 200 and the substrate 400. In practice, more photoelectronic units 300 may be included in the optical sensor of the present disclosure, and encapsulated between the microsphere support structure 200 and the substrate 400.

The photoelectronic unit 300 may include a light converting circuit. For example, the light converting circuit may include one or more photodetectors such as, but not limited to photodiodes, charge-coupled devices (CCDs), or complementary metal-oxide-semiconductor (CMOS).

A photosensitive region (including an active area) of the photoelectronic unit 300 may be aligned with the circular cross-sections (that are bottom surfaces) of one or more of the plurality of microsphere lenses 100. The active area of the photodiode is a detection region where light is received and converted into an electrical signal.

The photoelectronic unit 300 is configured to receive a light that travels through the microsphere lens(es) 100 and the microsphere support structure 200. For example, the photoelectronic unit 300 may be configured to receive a light that reflects internally at least once in the microsphere support structure 200.

As light travels through any one of the plurality of microsphere lens(es) 100, various phenomena such as reflection, scattering, absorption, total internal reflection, and diffraction may occur, which depend on material characteristics and geometric parameters of the one of the plurality of microsphere lenses 100.

That is, when light passes through the microsphere lens(es) 100, not every light ray is still necessarily refracted. However, refraction is the primary optical phenomenon because light changes direction due to a difference in refractive indices when the light passes from one medium (such as air) into another medium (that is the material of the microsphere lens 100).

In comparison with the conventional optical sensors whose lenses are aspherical lenses (such as biconvex, plano-convex, or aspheric lenses), the microsphere lenses 100 of the optical sensor of the present disclosure have a better focusing efficiency.

The conventional aspherical lenses can correct aberrations and achieve high-quality focusing, but at microscale or nanoscale, the microsphere lenses 100 of the optical sensor of the present disclosure are more suitable for micro-optical applications (such as photonics and super-resolution imaging) because of their size and spherical symmetry.

In practice, the optical sensor of the present disclosure may further include other processing circuits that may be disposed on the circuit layer 410 and electrically connected to the photoelectronic unit 300. These processing circuits may be configured to process, amplify, and convert the electrical signal (such as the photocurrent) generated by the photodetector, and may calculate the intensity of light received by the photoelectronic unit 300 based on the electrical signal and further calculate a distance according to the intensity of the incident light.

It is worth noting that, in comparison with the conventional optical sensors, the optical sensor of the present disclosure includes the microsphere lens(es) 100 for effectively enhancing a light-focusing performance thereof by directing more light onto the photoelectronic unit 300 such as photodiodes or other photodetectors described above, thereby improving an overall detection efficiency and sensitivity of the optical sensor of the present disclosure.

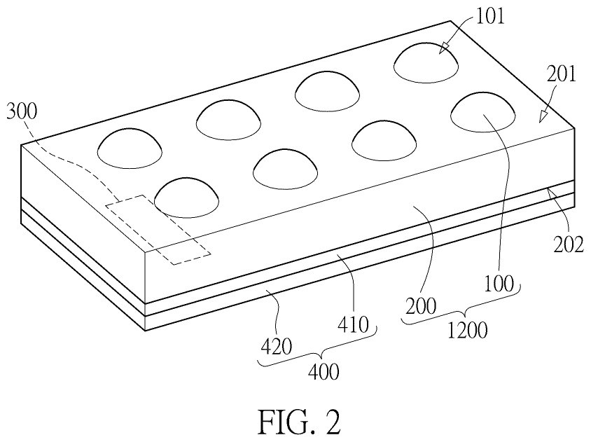

Reference is made to FIG. 2, which is a schematic structural view of an optical sensor having a microsphere structure according to a second embodiment of the present disclosure.

The descriptions of the second embodiment that are the same as the descriptions of the first embodiment are not repeated herein.

A difference between of the second and first embodiments is that, as shown in FIG. 2, in the second embodiment, the plurality of microsphere lenses 100 are arranged in an array of 4 rows and 2 columns.

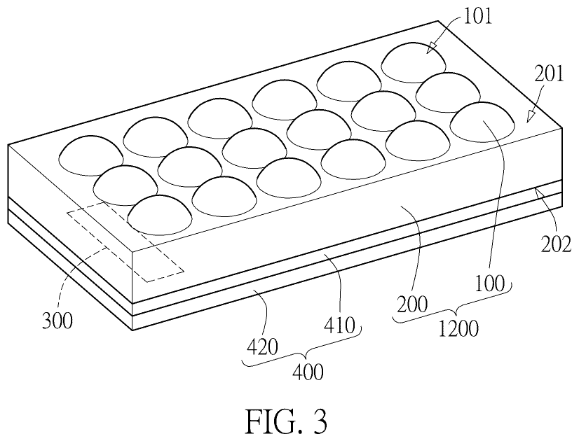

Reference is made to FIG. 3, which is a schematic structural view of an optical sensor having a microsphere structure according to a third embodiment of the present disclosure.

The descriptions of the third embodiment that are the same as the descriptions of the first embodiment are not repeated herein.

A difference between of the third and first embodiments is that, as shown in FIG. 3, in the third embodiment, the plurality of microsphere lenses 100 are arranged in an array of 6 rows and 3 columns.

It should be understood that, the arrangement and the number of the microsphere lenses 100 are only exemplified in the embodiments of the present disclosure, and in practice, they may be adjusted according to actual requirements.

Each or any one of the plurality of microsphere lenses 100 shown in FIG. 1 to FIG. 3 may be the same as the microsphere lens 100 shown in FIG. 4, FIG. 5, FIG. 6 or FIG. 7, which is specifically described below.

Reference is made to FIG. 4, which is a side view of a microsphere lens included in an optical sensor having a microsphere structure according to a fourth embodiment of the present disclosure.

In current applications, the microsphere lens 100 disposed on the microsphere support structure 200 is typically an incomplete sphere lens, such as a hemispherical lens as shown in FIG. 4 or another sphere being smaller than the hemispherical lens.

As shown in FIG. 4, in the fourth embodiment, a height of the microsphere lens 100 is equal to a radius R of the microsphere lens 100. The radius R described herein is a maximum radius of the circular cross-section area of any one of the plurality of microsphere lenses 100.

In other words, a distance between an apex of the microsphere lens 100 and the front surface 201 of the microsphere support structure 200 is equal to the radius R of the microsphere lens 100.

In practice, the height of the microsphere lens 100 may be within a range from the radius R to one-third of the radius R of the microsphere lens 100.

A thickness T200 of the microsphere support structure 200 is within a range from 10% to 100% of the radius R.

Reference is made to FIG. 5, which is a side view of a microsphere lens included in an optical sensor having a microsphere structure according to a fifth embodiment of the present disclosure.

In the fifth embodiment, a height of the microsphere lens 100 is equal to two-thirds of the radius R of the microsphere lens 100. In other words, a distance between an apex of the microsphere lens 100 and the front surface 201 of the microsphere support structure 200 is equal to two-thirds of the radius R of the microsphere lens 100.

In practice, the height of the microsphere lens 100 may be within a range from two-thirds of the radius R of the microsphere lens 100 to one-third of the radius R of the microsphere lens 100.

Reference is made to FIG. 6, which is a side view of a microsphere lens 100 included in an optical sensor having a microsphere structure according to a sixth embodiment of the present disclosure.

In the sixth embodiment, a height of the microsphere lens 100 is equal to one-half of the radius R of the microsphere lens 100. In other words, a distance between an apex of the microsphere lens 100 and the front surface 201 of the microsphere support structure 200 is equal to one-half of the radius R of the microsphere lens 100. In practice, the height of the microsphere lens 100 may be within a range from one-half of the radius R of the microsphere lens 100 to one-third of the radius R of the microsphere lens 100.

Reference is made to FIG. 7, which is a side view of a microsphere lens 100 included in an optical sensor having a microsphere structure according to a seventh embodiment of the present disclosure. In the seventh embodiment, a height of the microsphere lens 100 is equal to one-third of the radius R of the microsphere lens 100. In other words, a distance between an apex of the microsphere lens 100 and the front surface 201 of the microsphere support structure 200 is equal to one-third of the radius R of the microsphere lens 100. Thirteen configurations of the microsphere lenses 100 of the optical sensor of the present disclosure are listed in the following first table:

| Count Value | | Evaluation |
|---|---|---|
| of Lay Ray | Type of Lens | Value |
| 7373.1 | Silicon wafer Material | 1 |
| 7685.8 | Centered | 1.02 |

| | Lens(es) | Pitch | Radius | |
|---|---|---|---|---|
| 8615.3 | 1 microsphere lens | 0.22 mm | 0.075 mm | 1.14 |
| 7464.7 | 15 microsphere lenses | 0.08 | 0.008 | 0.99 |
| 7617.4 | 1 microsphere lens | 0.22 | 0.12 | 1.01 |
| 9487.5 | 1 microsphere lens | 0.26 | 0.12 | 1.26 |
| 10032 | 1 microsphere lens | 0.26 | 0.09 | 1.33 |
| 10292 | 2 microsphere lenses | 0.226 | 0.09 | 1.36 |
| 10716 | 4 microsphere lenses | 0.26 | 0.09 | 1.42 |
| 10941 | 6 microsphere lenses | 0.26 | 0.09 | 1.45 |
| 11060 | 8 microsphere lenses | 0.26 | 0.09 | 1.46 |
| 7950.5 | 1 microsphere lens | 0.2 | 0.05 | 1.05 |
| 10373 | 3 microsphere lenses | 0.26 | 0.09 | 1.37 |
| 11256 | 18 microsphere lenses | 0.26 | 0.09 | 1.49 |

Thirteen configurations of the microsphere lenses 100 of the optical sensor of the present disclosure are exemplified, measurement results of which are tabulated in the first table.

For each of the thirteen configurations of the microsphere lenses 100, the number of the light rays received by the photoelectronic unit 300 is counted to generate a count value, and an evaluation value is generated according to the count value. The evaluation value is positively correlated with the count value.

The evaluation value of the conventional optical sensor that does not include any microsphere lens 100 is used as a reference evaluation value, for example, is equal to “1”.

If the evaluation value of the configuration is higher than the reference evaluation value, the configuration is considered as a positive configuration where the number of the light rays received by the photoelectronic unit 300 is increased to be more than that of the conventional optical sensor that does not include any microsphere lens.

In the configuration of the optical sensor including the six microsphere lenses 100 shown in FIG. 1, the eight microsphere lenses 100 shown in FIG. 2 or the eighteen microsphere lenses 100 shown in FIG. 3, a pitch between centers respectively of two adjacent ones of the plurality of microsphere lenses 100 may be 0.26 mm as listed in the first table, and the radius R of each of the plurality of microsphere lenses 100 may be 0.09 mm listed in the first table.

The evaluation value of the optical sensor including the six microsphere lenses 100 shown in FIG. 1 is 1.45 listed in the first table, the evaluation value of the optical sensor including the eight microsphere lenses 100 shown in FIG. 2 is 1.46 listed in the first table, and the eighteen microsphere lenses 100 shown in FIG. 3 is 1.49 listed in the first table. Each of these evaluation values is larger than the evaluation value “1” of the conventional optical sensor that does not include any microsphere lens 100, and is larger than the evaluation values of others of the configurations of the optical sensor of the present disclosure.

If the optical sensor of the present disclosure includes the one, two, three or four microsphere lenses 100, the optical sensor also has the evaluation value being larger than that of the conventional sensor.

The evaluation value “1” corresponds to a percentage of 100%, the evaluation value “1.45” correspond to a percentage of 145%, the evaluation value “1.46” corresponds to a percentage of 146%, the evaluation value “1.49” corresponds to a percentage of 149%, and so on. The larger the percentage is, the more the number of the light rays received by the photoelectronic unit 300, and the higher the light collection efficiency of the optical sensor is.

Therefore, it is apparent that, the optical sensor of the present disclosure including the microsphere lens(es) 100 has a better light collection efficiency than the conventional sensor.

Under the same light source emitting the same light ray, the number of the light rays sensed by the optical sensor of the present disclosure is 45% more than that sensed by the conventional optical sensor.

The optical sensor of the present disclosure includes the microsphere lenses 100 as a light transmission structure or a light collection structure thereof, the physical structure of which is different from that of the conventional optical sensor. As described above, the one or more microsphere lenses 100 of the optical sensor of the present disclosure are proven to be able to truly direct and concentrate a larger amount of the light onto the active area of the photoelectronic unit 300 such as the photodiode, thereby significantly improving performance of the optical sensor of the present disclosure.

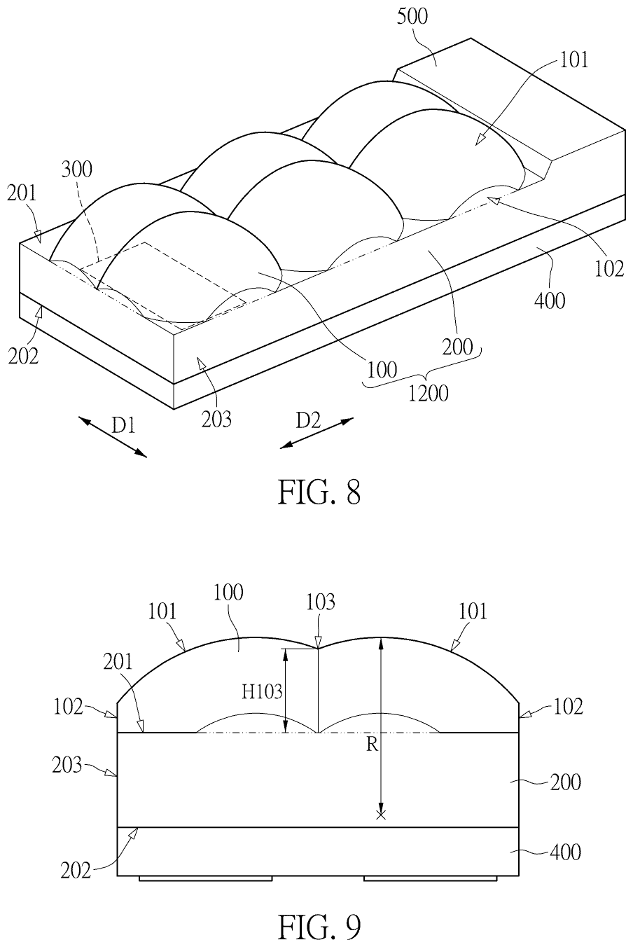

It should be understood that, if the optical sensor of the present disclosure includes other numbers of microsphere lenses 100 that are not shown in FIG. 8, the optical sensor of the present disclosure also has a better light collection efficiency than the conventional optical sensor. The number of the microsphere lenses 100 as shown in FIG. 8 are exemplified, but the present disclosure is not limited thereto.

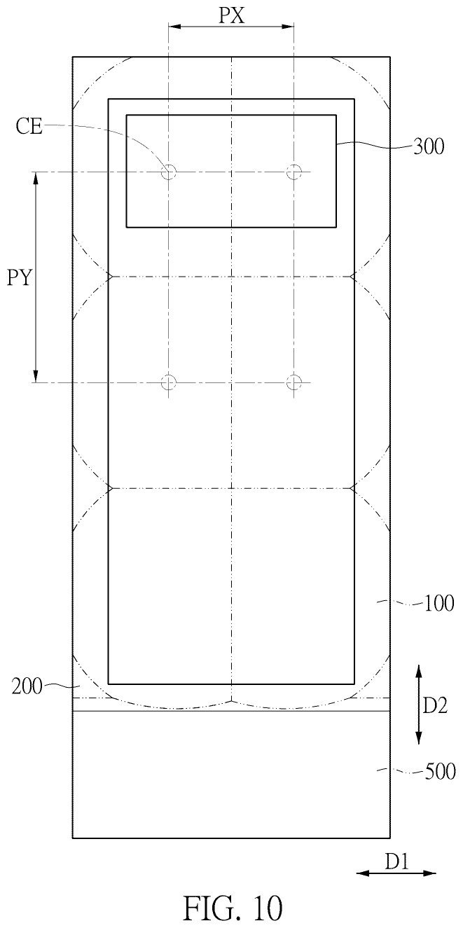

Reference is made to FIG. 8, FIG. 9 and FIG. 10, in which FIG. 8 is a schematic structural view of an optical sensor having a microsphere structure according to an eighth embodiment of the present disclosure, FIG. 9 is a side view of FIG. 8, and FIG. 10 is a plan view of the optical sensor having a microsphere structure according to the eighth embodiment of the present disclosure.

Differences between the eighth embodiment and the first to third embodiments are described below.

In the eighth embodiment, the light-permeable layer 1200 of the optical sensor of the present disclosure further includes a protrusion 500.

The protrusion 500 is disposed on the microsphere support structure 200 and is arranged at one side of the plurality of microsphere lenses 100. A height of the protrusion 500 is larger than the height of each of the plurality of microsphere lenses 100. Moreover, the plurality of microsphere lenses 100, the microsphere support structure 200, and the protrusion 500 provided by the present embodiment can be integrally formed as a single one-piece structure.

The one side surface of each one of the plurality of microsphere lenses 100 may be cut to form a flat surface instead of a surface having the spherical curvature, and the flat surface is a lateral surface 102 of the one of the plurality of microsphere lenses 100.

The microsphere support structure 200 may have a surrounding lateral surface 203 that is coplanar with the lateral surface 102 of each of the plurality of microsphere lenses 100.

In detail, the surrounding lateral surface 203 includes a plurality of sub-lateral surfaces. Each of the plurality of sub-lateral surfaces is coplanar with the lateral surface 102 of one of the plurality of microsphere lenses 100. The plurality of sub-lateral surfaces are respectively coplanar with different ones of the plurality of lateral surfaces 102 of the plurality of microsphere lenses 100.

In addition or alternatively, the protrusion 500 may also function as a protective structure configured to protect the plurality of microsphere lenses 100, thereby preventing the microsphere lenses 100 from being damaged by external objects.

As shown in FIG. 8, in the eighth embodiment, the plurality of microsphere lenses 100 are arranged in an array of 6 rows and 2 columns, and photoelectronic unit 300 may be a circuit integrated on a chip, but the present disclosure is not limited thereto.

A surface of each one of the plurality of microsphere lenses 100 is at least partially attached to or in direct contact with surfaces of another ones of the plurality of microsphere lenses 100 that are disposed adjacent thereto.

Any two ones of the plurality of microsphere lenses 100 adjacent to each other have a connection boundary 103 of spherical surfaces 101 of the two ones of the plurality of microsphere lenses 100. As shown in FIG. 9, a distance H103 between the connection boundary 103 and a top surface 201 of the microsphere support structure 200 can be within a range from 10% to 50% of the radius R of each of the two ones of the plurality of microsphere lenses 100.

Each of the plurality of microsphere lenses 100 has a top point CE arranged away from the microsphere support structure 200, any two ones of the plurality of microsphere lenses 100 arranged along a first direction D1 and adjacent to each other define a first pitch PX between the top points CE thereof, and the first pitch PX can be within a range from 12.5% to 150% of the radius R.

Any two ones of the plurality of microsphere lenses 100 arranged along a second direction D2 perpendicular to the first direction D1 and adjacent to each other define a second pitch PY between the top points CE thereof, and the second pitch PY can be within a range from 75% to 250% of the radius R.

For example, the first direction D1 is a horizontal direction or a width direction and the first pitch PX is a horizontal pitch PX shown in FIG. 10, and the second direction D2 is a longitudinal direction or a length direction and the second pitch PY is a longitudinal pitch PY shown in FIG. 10.

The second pitch PY is equal to the first pitch PX in the configurations shown in FIG. 1 to FIG. 3, but the second pitch PY is different from, for example, is larger than the first pitch PX in the configuration shown in FIG. 10.

For example, in the configuration shown in FIG. 10, a ratio of the first pitch PX to the radius R of the microsphere lens 100 falls within a range of 0.32 to 0.84, and a ratio of the second pitch PY to the radius R of the microsphere lens 100 falls within a range of 1.36 to 2.11.

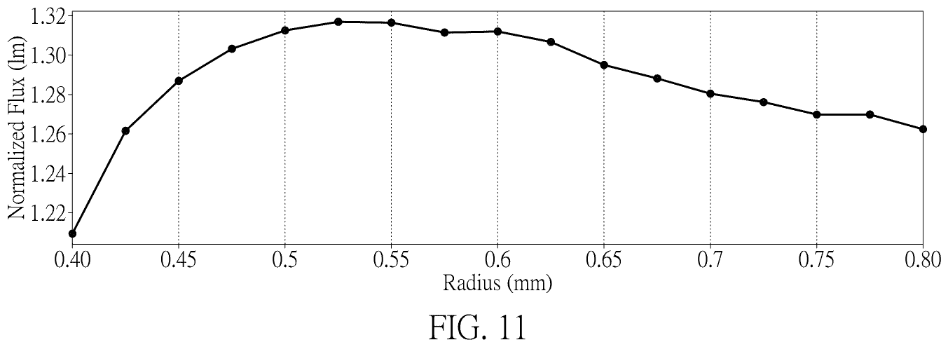

Reference is made to FIG. 8 to FIG. 11, in which FIG. 11 is a schematic diagram of a curve of a normalized flux versus radiuses of the microsphere lens 100 of the optical sensor having a microsphere structure according to the eighth embodiment of the present disclosure.

A curve of the normalized flux of the light received by the photoelectronic unit 300 versus the radius R of each of the plurality of microsphere lenses 100 is shown in FIG. 11.

If the radius R of each of the plurality of microsphere lenses 100 included in the optical sensor of the present disclosure falls within a range of 0.5 mm to 0.6 mm, the normalized flux of the light received by the photoelectronic unit 300 reaches larger values.

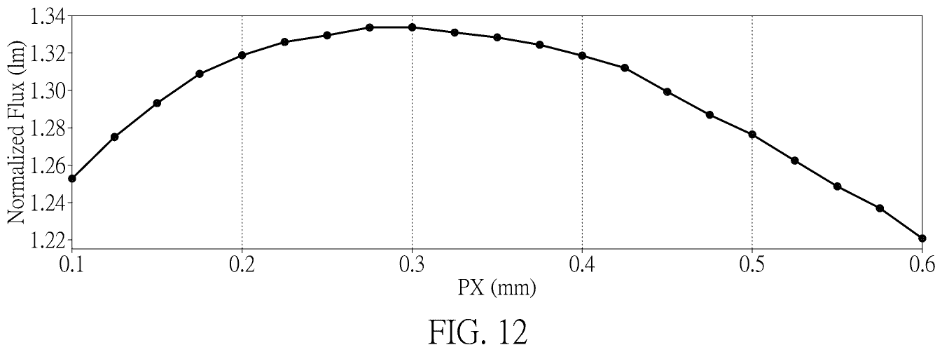

Reference is made to FIG. 8, FIG. 10 to FIG. 12, in which FIG. 12 is a schematic diagram of a curve of a normalized flux versus a horizontal pitch of the microsphere lens 100 of the optical sensor having a microsphere structure according to the eighth embodiment of the present disclosure.

A curve of the normalized flux of the light received by the photoelectronic unit 300 versus the first pitch PX is shown in FIG. 12.

If the first pitch PX between the centers respectively of two adjacent ones of the plurality of microsphere lenses 100 falls within a range of 0.25 mm to 0.35 mm, the normalized flux of the light received by the photoelectronic unit 300 reaches larger values.

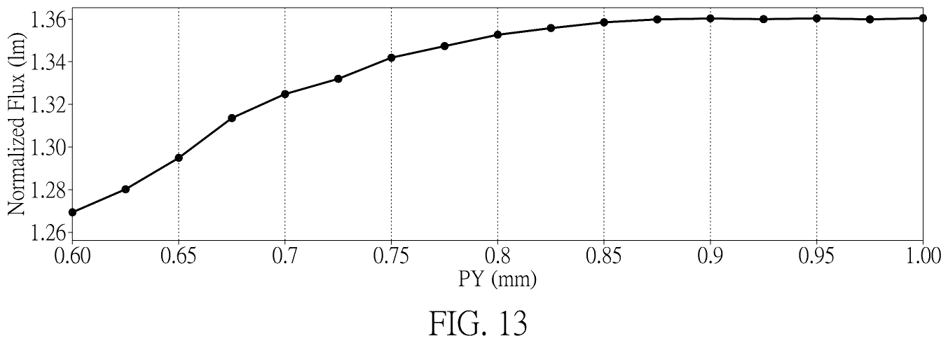

Reference is made to FIG. 8, FIG. 10 and FIG. 13, in which FIG. 13 is a schematic diagram of a curve of a normalized flux versus a longitudinal pitch of the microsphere lens 100 of the optical sensor having a microsphere structure according to the eighth embodiment of the present disclosure.

A curve of the normalized flux of the light received by the photoelectronic unit 300 versus the second pitch PY is shown in FIG. 13.

The larger the second pitch PY between the centers respectively of two adjacent ones of the plurality of microsphere lenses 100 is, the larger the normalized flux of the light received by the photoelectronic unit 300 is. The second pitch PY is proportional to the normalized flux of the light received by the photoelectronic unit 300.

In other words, the normalized flux of the light received by the photoelectronic unit 300 is increased with an increase in the second pitch PY between the centers respectively of two adjacent ones of the plurality of microsphere lenses 100.

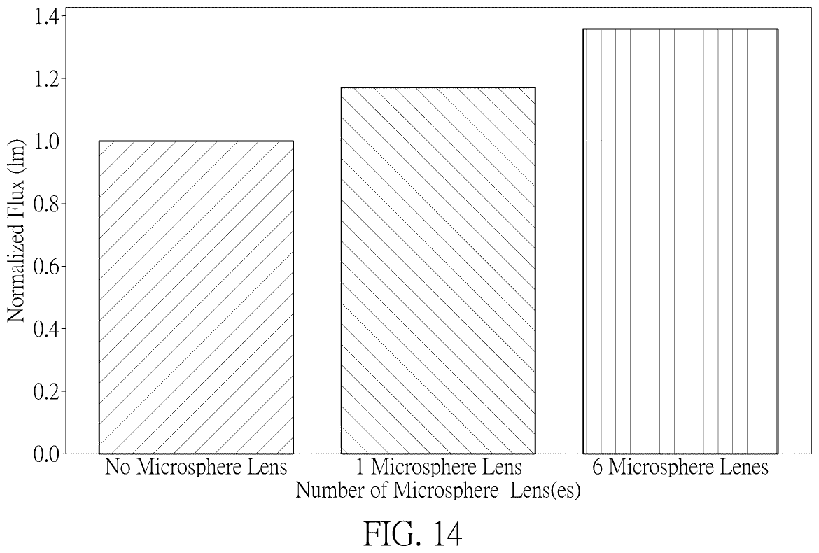

Reference is made to FIG. 8, FIG. 10 and FIG. 14, in which FIG. 14 is a bar graph in which a vertical axis represents a normalized flux and a horizontal axis represents the number of microsphere lenses of the optical sensor having the microsphere structure according to the eighth embodiment of the present disclosure.

The normalized flux of the conventional optical sensor that does not include any microsphere lens 100 is 1 (lm).

In contrast, the optical sensor of the present disclosure that includes the one microsphere lens 100 has the normalized flux of about 1.18 lm, and the optical sensor of the present disclosure that includes the six microsphere lenses 100 has the normalized flux of about 1.36 lm.

It is apparent that, the optical sensor of the present disclosure includes the microsphere lens(es) 100 by which the amount of the light received by the photoelectronic unit 300 is increased, thereby enhancing the sensitivity of the optical sensor of the present disclosure.

Therefore, the sensitivity of the optical sensor of the present disclosure is better than that of the conventional optical sensor.

In conclusion, the present disclosure provides the optical sensor having the microsphere structure. In comparison with the conventional optical sensor, the optical sensor of the present disclosure further includes the one or more microsphere lens(es) that can very effectively focus the incident light onto a small area such as the active area of the photoelectronic unit such as the photodiode, significantly for example, increasing the amount of the light collected, and improving the sensitivity and a signal-to-noise ratio of the optical sensor. Therefore, the optical sensor of the present disclosure has better light focusing efficiency than the conventional optical sensor.

Furthermore, due to the small size and simple shape of the microsphere lens(es), the optical sensor of the present disclosure is easier to be integrated into a semiconductor chip or a micro-optical system than the conventional optical sensor having larger and bulkier lens.

Furthermore, large quantities of the microsphere lenses of the optical sensor of the present disclosure are able to be produced through simple processes such as self-assembly or mold forming, reducing manufacturing costs and improving device-to-device consistency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical sensor having a microsphere structure, comprising:
a substrate;
a light-permeable layer including:
a microsphere support structure disposed on the substrate; and
a microsphere lens disposed on the microsphere support structure,
wherein a height of the microsphere lens is less than or equal to a radius of the microsphere lens; and
a photoelectronic unit electronically connected to the substrate;
wherein the photoelectronic unit is configured to receive a light that travels through the microsphere lens and the microsphere support structure.

2. The optical sensor having the microsphere structure according to claim 1, wherein the height of the microsphere lens is within a range from the radius to one-third of the radius.

3. The optical sensor having the microsphere structure according to claim 1, wherein the height of the microsphere lens is within a range from two-thirds of the radius to one-third of the radius.

4. The optical sensor having the microsphere structure according to claim 1, wherein the height of the microsphere lens is within a range from one-half of the radius to one-third of the radius.

5. The optical sensor having the microsphere structure according to claim 1, wherein the photoelectronic unit is encapsulated between the microsphere support structure and the substrate.

6. The optical sensor having the microsphere structure according to claim 1, wherein a thickness of the microsphere support structure is within a range from 10% to 100% of the radius.

7. The optical sensor having the microsphere structure according to claim 1, wherein the photoelectronic unit is configured to receive a light that reflects internally at least once in the microsphere support structure.

8. An optical sensor having a microsphere structure, comprising:
a substrate;
a light-permeable layer including:
a microsphere support structure disposed on the substrate; and
a plurality of microsphere lenses disposed on the microsphere support structure, wherein a height of each of the plurality of microsphere lenses is less than or equal to a radius of each of the microsphere lenses; and
a photoelectronic unit electronically connected to the substrate;
wherein the photoelectronic unit is configured to receive a light that travels through at least one of the plurality of microsphere lenses or the microsphere support structure.

9. The optical sensor having the microsphere structure according to claim 8, wherein the plurality of microsphere lenses are arranged in an array.

10. The optical sensor having the microsphere structure according to claim 8, wherein the plurality of microsphere lenses are separate from each other.

11. The optical sensor having the microsphere structure according to claim 8, wherein any two ones of the plurality of microsphere lenses adjacent to each other have a connection boundary of spherical surfaces thereof, and a distance between the connection boundary and a top surface of the microsphere support structure is within a range from 10% to 50% of the radius.

12. The optical sensor having the microsphere structure according to claim 8, wherein the height of each or any one of the plurality of microsphere lenses is within a range from the radius to one-third of the radius.

13. The optical sensor having the microsphere structure according to claim 8, wherein the height of each or any one of the plurality of microsphere lenses is within a range from two-thirds of the radius to one-third of the radius.

14. The optical sensor having the microsphere structure according to claim 8, wherein the height of each or any one of the plurality of microsphere lenses is within a range from one-half of the radius to one-third of the radius.

15. The optical sensor having the microsphere structure according to claim 8, wherein the microsphere support structure and the plurality of microsphere lenses are integrally formed as a single one-piece structure.

16. The optical sensor having the microsphere structure according to claim 8, wherein each of the plurality of microsphere lenses has a top point arranged away from the microsphere support structure, any two ones of the plurality of microsphere lenses arranged along a first direction and adjacent to each other define a first pitch between the top points thereof, and the first pitch is within a range from 12.5% to 150% of the radius.

17. The optical sensor having the microsphere structure according to claim 16, wherein any two ones of the plurality of microsphere lenses arranged along a second direction perpendicular to the first direction and adjacent to each other define a second pitch between the top points thereof, and the second pitch is within a range from 75% to 250% of the radius.

18. The optical sensor having the microsphere structure according to claim 8, wherein the light-permeable layer further includes a protrusion that is disposed on the microsphere support structure and that is arranged at one side of the plurality of microsphere lenses, and a height of the protrusion is larger than the height of each of the plurality of microsphere lenses.

19. The optical sensor having the microsphere structure according to claim 8, wherein the microsphere support structure has a surrounding lateral surface, and each of the plurality of microsphere lenses has at least one lateral surface that is coplanar with the surrounding lateral surface.

20. The optical sensor having the microsphere structure according to claim 8, wherein the photoelectronic unit is configured to receive a light that travels through the at least one of the plurality of the microsphere lenses and the microsphere support structure.
